(19) United States
(12) Patent Application Publication
(10) Pub. No.: US 2018/0170668 A1
(43) Pub. Date: Jun. 21, 2018

(54) SANITARY APPARATUS

(71) Applicant: Whoosh Washrooms, Hampshire (GB)

(72) Inventor: Wayne Magahy, Stockbridge (GB)

(21) Appl. No.: 15/843,873

(22) Filed: Dec. 15, 2017

(30) Foreign Application Priority Data
Dec. 15, 2016 (GB) 1621338.1

(51) Int. Cl. B65F 1/16; B65F 1/14; B65F 1/12

(52) U.S. Cl. CPC B65F 1/1607; B65F 1/141; B65F 1/0053; B65F 1/1623; B65F 1/12

(57) ABSTRACT

A lid for a sanitary bin may include a container with a container interior, the container including an end wall, at least one side wall extending from a first end connected to the end wall to a distal second end, the at least one side wall further including a waste aperture, and the at least one side wall further comprising at least one slit extending from the second end towards the first end. A sanitary bin using a lid in the above form is also described. In this way, a hygienic sanitary bin suitable for high intensity use is provided.

This application claims priority to United Kingdom Patent Application No 1621338.1, filed Dec. 15, 2016, the entire content of which is incorporated herein by reference.

### TECHNICAL FIELD

The present disclosure relates to sanitary apparatus, and more specifically to a sanitary bin and its lid.

### BACKGROUND

Sanitary bins have long been installed in public toilets and other locations where many people are expected to use a single bathroom facility. Typically, sanitary bins are installed in these areas with their affixation to a wall or the floor of the bathroom facility. Whilst such an installation is advantageous as it secures the sanitary bin in position, it also has the undesired effect of rendering some surfaces of the bin, and the areas surrounding the bin, difficult to clean.

Whilst these issues can be mitigated to some extent with the installation of freestanding bins, or more sympathetically securing a sanitary bin to a wall or floor, further features of sanitary bins as presently available may present a hygiene issue.

For example, it is common knowledge that a sanitary bin should be closed when not in use, to prevent odours from the bin escaping into the surrounding environment. In the state of the art, such closure mechanisms frequently include several moving mechanical parts, such as springs or slideable interlocking parts. These mechanical parts often have relatively complex surfaces, increasing the difficulty of cleaning the bin as required. Additionally, any moving parts may break or require maintenance, potentially resulting in the sanitary bin becoming inoperable or unusable for a period.

### SUMMARY

According to a first aspect of the present disclosure there is provided a lid for a sanitary bin, said lid comprising a container with a container interior, said container comprising an end wall, at least one side wall extending from a first end connected to said end wall to a distal second end, said side wall further comprising a waste aperture, and said side wall further comprising at least one slit extending from said second end towards said first end.

In this way, there is provided a lid for a sanitary bin which allows for the provision of a more hygienic sanitary bin, suitable for high intensity use in several environments. Such a sanitary bin is advantageous as it reduces the opportunity for disease, infection, and bacteria to be passed between users, whilst preventing odours from escaping into the surrounding environment.

Preferably, the lid further comprises at least one tab extending outwardly from the side wall.

Preferably, the side wall extends from the perimeter of the end wall. It may also be preferable for the side wall to extend from the end wall in an area proximate to the perimeter of the end wall.

Preferably the side wall extends to define a perimeter greater than that of the end wall. More preferably, the side wall extends to define a perimeter more than 3% greater than that of the end wall. Still more preferably, the side wall extends to define a perimeter more than 5% greater than that of the end wall.

Preferably the second end of the side wall defines the largest perimeter of the side wall. More preferably, the perimeter of the side wall increases smoothly between the first end and the second end.

Preferably the perimeter defined by the end wall and the perimeter defined by the side wall are substantially the same geometric shape. More preferably, the perimeter defined by the end wall and the perimeter defined by the second end of the side wall are substantially the same geometric shape.

Preferably, the slit extends perpendicularly from said second end towards said first end. Preferably, the slit extends through the full thickness of the side wall. Preferably the slit is linear.

Preferably, the slit is tapered where it meets the second end. More preferably, the slit narrows as it extends away from the second end. Still more preferably, the slit narrows by more than 10% as it extends away from the second end.

Preferably, the termination of the slit distal from the second end comprises an aperture. More preferably the aperture has curved edges. Still more preferably, the aperture is a circle.

Preferably, the tab terminates proximate the slit. More preferably, the tab terminates adjacent to the slit.

Preferably, the lid comprises a pair of opposing slits. More preferably, the tab terminates adjacent to both slits.

Preferably the tab extends outwardly from the second end of the side wall. Preferably, the tab extends perpendicularly from the side wall. Preferably the tab extends outwardly form at least 30% of the perimeter of the side wall. More preferably, the tab extends outwardly from the majority of the perimeter of the side wall.

Preferably, the lid comprises a plurality of tabs. More preferably, each of this plurality of tabs terminates adjacent to a slit. Preferably, the plurality of tabs is equally spaced around the perimeter of said side wall.

Preferably, the tab comprises a planar engagement face. Preferably the tab comprises two substantially planar faces. More preferably, these substantially planar faces are opposed.

Preferably, the end wall is curved. More preferably, the outer surface of the end wall is convex in shape. Preferably, the lid comprises at least one handle extending outwardly from the end wall. Preferably, the handle comprises a textured grip.

Preferably the lid comprises at least one fin extending into the container interior. Preferably the fin is planar. More preferably, the lid comprises a plurality of fins extending into the container interior.

Preferably, the lid has a circular perimeter.

According to a second aspect of the present disclosure there is provided a sanitary bin comprising a bin portion, said bin portion comprising a base and a tapered tube extending and broadening from said base to form a bin interior, said sanitary bin further comprising the lid of any preceding claim, wherein said lid is sized to fit within said tapered tube, and further wherein said lid is slidably movable within said tapered tube, such that said sliding motion of said lid towards said base of said bin portion exerts a force on said lid such that said slit narrows in width.

In this way, there is provided a sanitary bin which provides increased level of hygiene in a high throughput environment.

Preferably, the bin portion further comprises at least one flange extending into the bin interior from the tapered tube and the flange and the tab engage to prevent complete removal of said lid from the tapered tube.

Preferably, the flange is located at the end of the tapered tube distal from the base. Preferably, the flange extends around the majority of the perimeter of the tapered tube. More preferably, the flange extends around greater than 80% of the perimeter of the tapered tube

### BRIEF DESCRIPTION OF THE DRAWINGS

Embodiments of the present disclosure will now be described by way of example only and with reference to the accompanying drawings.

FIGS. 1A-1D are schematic illustrations of an embodiment of a lid in accordance with the present disclosure.

FIG. 2 is a schematic illustration of an open bin in accordance with the present disclosure, using a lid in accordance with the present disclosure.

FIG. 3 is a schematic illustration of a partially closed bin in accordance with the present disclosure, using a lid in accordance with the present disclosure.

FIG. 4 is a schematic illustration of a closed bin in accordance with the present disclosure, using a lid in accordance with the present disclosure.

### DETAILED DESCRIPTION

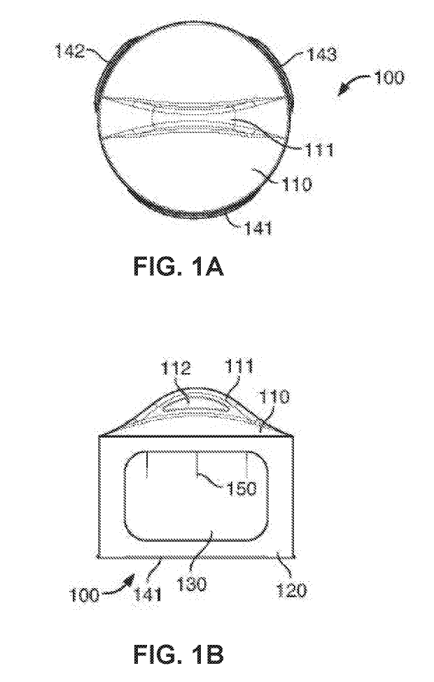

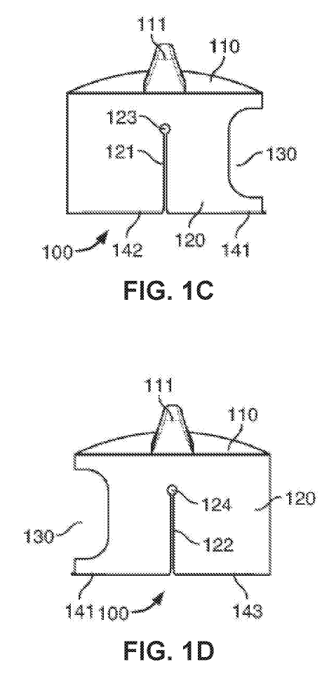

Referring to FIGS. 1A-1D of the drawings, there are depicted four views of a lid 100 in accordance with the present disclosure. Here, the lid 100 comprises an end wall 110 and a side wall 120, the side wall 120 extending downwardly from the outer edge of the end wall 110. In this formation, the side wall 120 and the end wall 110 together form a container structure. As the end wall 110 is generally circular in shape, the container structure formed by the end wall 110 and the side wall 120 is generally cylindrical.

FIGS. 1A-1D also illustrates a curved end wall 110. The end wall 110 is curved away from the side wall 120, such that the outer surface of the end wall 110 is convex in shape. The radius of curvature of the convex end wall 110 is substantially similar across the entire surface of the end wall 100, except in the area of the handle 111. The handle 111 is located on the exterior surface of the end wall 110, and protrudes outwardly. As such, the handle 111 extends beyond the end wall 110 of the lid 100, such that a user may grip it. The handle 111 includes a textured surface 112 to increase the grip of the user on the handle 111 and thus the lid 100.

The side wall 120 extends from the entire perimeter of the end wall 110, the side wall 120 and the end wall 110 transitioning smoothly into one another at their interface. The side wall 120 extends substantially perpendicularly from the end wall 100, although variations from this perpendicular arrangement are envisaged by the applicant. The side wall 120 includes a first end, this first end connected directly to the end wall 110, and a second end located away from the first end. The side wall 110 extends between these first and second ends, and is curved with a substantially constant radius of curvature.

The side wall 120 also includes a first slit 121 and a second slit 122. Both the first slit 121 and the second slit 122 extend from the second end of the side wall 120 towards the first end of the side wall 120. Here, both the first slit 121 and the second slit 122 extend substantially perpendicularly to the second end of the side wall 120, towards the first end of the side wall and parallel to the longitudinal axis of the container structure formed by the end wall 110 and the side wall 120. Both the first slit 121 and the second slit 122 have a tapered portion located adjacent to the second end of the side wall 120, this tapered portion of each slit narrowing as the distance from the second end of the side wall 120 is increased.

Where the first slit 121 is closest to the first end of the side wall 120, it terminates with an aperture 123. The aperture 123 illustrated in FIGS. 1A-1D is circular, the outer perimeter of this circular aperture 123 intersecting with the elongate slit 121. The second slit 122 terminates with a similar aperture 124. The slits 121, 122 themselves also extend through the full thickness of the side wall 120.

The first 121 and second 122 slits are located on the side wall 120 such that they are opposite one another. Located between the first 121 and second 122 slits, the side wall 120 also includes a waste aperture 130. The waste aperture 130 is located centrally between the first slit 121 and the second slit 122, and is large enough to allow the passage of a human hand. The waste aperture 130 is in the form of a rounded rectangle, the corners curved to reduce the risk of injury to a user, and to eliminate any well-defined vertices which may harbour bacteria.

A first tab 141, a second tab 142 and a third tab 143 also extend outwardly form the side wall 120 of the lid 100. These tabs 141,142,143 are located at the second end of the side wall 120, and extend outwardly from the side wall 120 to protrude outside of the container structure defined by the side wall 120 and the end wall 110. The first tab 141 is located below the waste aperture 130, and is longer than the second 142 or third 143 tabs. The first tab 141 has a length substantially equal to that of the waste aperture 130.

The second tab 142 is located such that it terminates adjacent to the second slit 121. Similarly, the third tab 143 is located such that it terminates adjacent to the second slit 122. Both the second tab 142 and the third tab 143 have the substantially the same length. In total, the first tab 141, the second tab 142 and the third tab 143 extend around the majority of the side wall 120 perimeter. Additionally, the surface of the first 141, second 142 and third tabs 143 located closest to the end wall 110 comprises an engagement surface. This engagement surface extends across the majority of each tab 141, 142 and 143 and comprises a substantially planar surface.

The lid 100 also includes fins 150 which extend into the interior of the container structure defined by the end wall 110 and the side wall 120. Each of the fins 150 depends downwardly from the end wall 110 in the form of a substantially planar, elongate member. Here, the lid 100 comprises three fins 150, each fin 150 regularly spaced across the interior surface of the end wall 110. Each fin 150 extends substantially perpendicularly from the end wall 110. Additionally, each fin 150 is positioned such that its length lies substantially perpendicularly to the waste aperture 130.

Overall, the lid 100 is formed in a single moulded structure. This moulded structure may be achieved using an injection moulding process or any other moulding process. The lid depicted in FIGS. 1A-1D comprises a plastics material, commonly polyethylene or polypropylene although the use of other materials is also envisaged. The lid 100 is made from a resiliently deformable material.

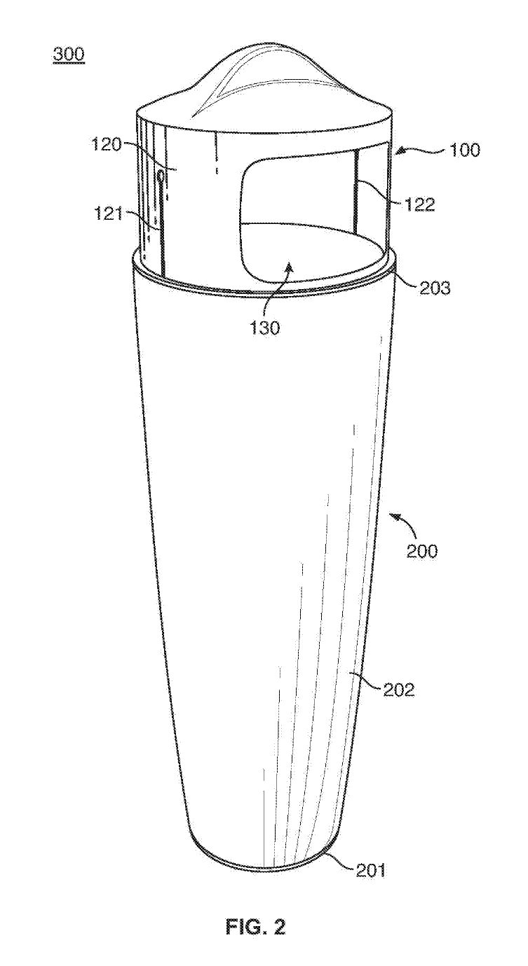

Referring now to FIG. 2, the insertion of the lid 100 into a bin portion 200 to form a sanitary bin 300 is depicted. Here, the bin portion 200 takes the form of a base 201 from which a tapered tube 202 extends in an upward direction. In FIG. 2, the base 201 is a circle and the tapered tube 202 is a cylinder with varying diameter, the tapered tube 202 extending from the perimeter of the base 201 to form a bin interior.

Moving along the tapered tube 202 away from the base, the radius of the tapered tube 202 increases, this rate of increase varying along the length of the tapered tube 202. An alternative version of the tapered tube 202, where the rate of increase of the diameter of the tapered tube 202 is constant (and the tapered tube is frustoconical) is also envisaged by the applicant. The tapered tube 202 may comprise metal, with a brushed metal surface optionally included to provide an aesthetic appeal. Additionally, the base 201 comprises pads or rubber feet which support the sanitary bin 300, providing cushioning and support on uneven floors.

The bin portion 200 further comprises a flange 203 which extends into the bin interior defined by the tapered tube 202 and the base 201. The flange 203 is located at the top end of the tapered tube 202, the end furthest from the base portion 201, where it extends around the entire perimeter of the tapered tube 202. The flange 203 is made of the same material as the tapered tube 202, and comprises substantially planar upper and lower surfaces. As such, as can be seen in FIG. 2, the flange 203 forms a ring-shaped structure around the top edge of the bin portion 202.

The lid 100 is sized to fit within the bin 200. The diameter of the side wall 120 of the lid 100 is such that the side wall 120 fits within the diameter defined by the tapered tube 202. In FIG. 2, the side wall 120 of the lid 100 lies in close proximity to the flange 203, and the tabs 141, 142, 143 extending outwardly form the side wall 120 are in contact with the interior surface of the tapered tube 202, below the flange 203. The lid 100 is inserted into the bin portion 200 by compressing the side wall 120 of the lid 100 such that its diameter is reduced, before the tabs 141, 142, 143 are located below the flange 203. The compression of the side wall 120 is then released, causing the side wall 120 to again increase in diameter such that the tabs 141, 142, 143 engage both the interior surface of the tapered tube 202 and the flange 203.

In use, the tapered tube 202 has a diameter which is slightly smaller that defined by the tabs 141, 142, 143, causing the tapered tube 202 to place a compressive force on the side wall 120, causing a small reducing in the diameter defined by the side wall 120. This reduction in diameter of the side wall 120 is accommodated by the narrowing of the slits 121, 122 in response to the compressive pressure exerted by the tapered tube 202. The compressive force on the side wall 120 holds the lid 100 in the open position, such that the waste aperture 130 is located above the top edge of the tapered tube 202, such that a user may place waste into the sanitary bin 300.

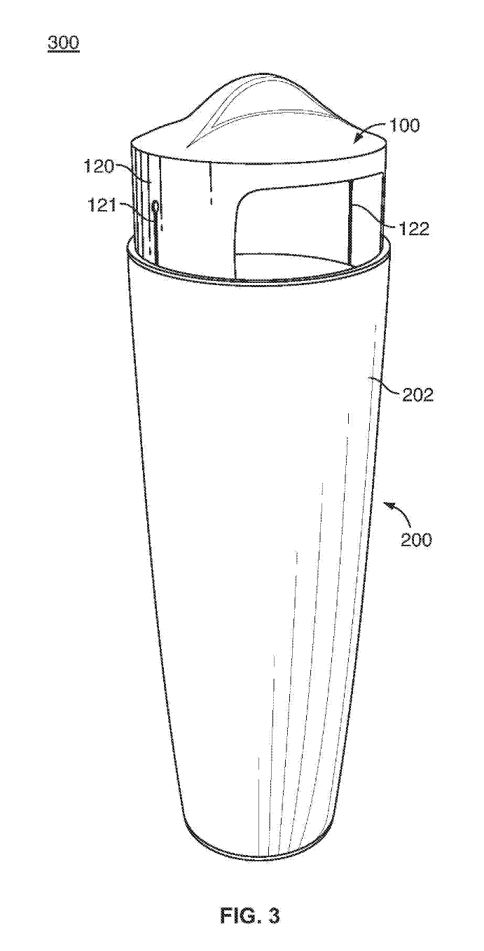

FIG. 3 illustrates the sanitary bin 300 in a partially closed state, wherein the lid 100 is pushed further into the tapered tube 202 of the bin portion 200. Here, a user may place a downward force on the lid 100 pushing it into the tapered tube 202. As the lid 100 travels further into the bin, the side wall 120 becomes increasingly compressed due to the ever-decreasing diameter of the tapered tube 202. This increased compression of the side wall 120 is accommodated by the narrowing of the first slit 121 and the second slit 122 as the lid travels further into the tapered tube 202.

As the lid 100 is inserted into the tapered tube 202, the tabs 141, 142, 143 exert an outwards force on the interior surface of the tapered tube 202. This outward pressure ensures the lid 100 remains in position, unless moved by a user, due to a frictional fit between the tabs 141, 142, 143 and the interior surface of the tapered tube 202.

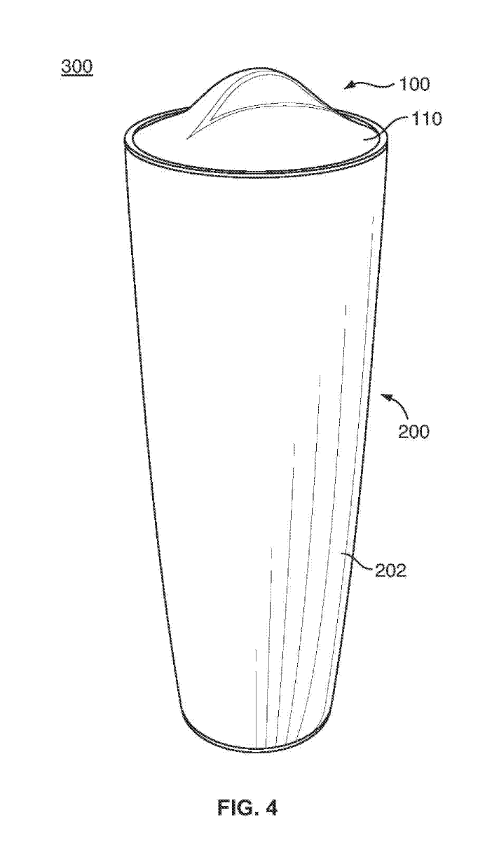

The insertion of the lid 100 into the bin portion 200 continues until the end wall 110 lies adjacent to the flange 203 as illustrated in FIGS. 3 and 4. Here, the movement of the lid is ceased as the first slit 121 and the second slit 122 may have no further capacity to narrow, or because the side wall 120 comes to rest against a stop located on the inner surface of the tapered tube 202. Such features prevent the over insertion of the lid 100 into the bin portion 200.

To remove the lid 100 from the bin portion 200 such that waste may be inserted into the bin via the waste aperture 130, the user may exert an upwards force on the lid 100 using the handle 110. This force will cause the lid 100 to be extended from the tapered tube 202, once again exposing the waste aperture 130 to the user. Complete removal of the lid 100 from the tapered tube 202 is prevented by the interaction of the tabs 141, 142, 143 and the flange 203 when the lid 100 is in the open position. This interaction between the tabs 141, 142, 143 and the flange 203 is an abutment of the respective members.

Due to resiliently deformable nature of the lid material, the process of opening and closing the sanitary bin 300 can be undertaken repeatedly before any fatigue effects or mechanical weakening of the lid 100 is seen. As such, the sanitary bin hereinbefore described is suitable for high intensity use in public bathrooms and other communal facilities.

1. A lid for a sanitary bin, the lid comprising:
a container with a container interior, the container comprising:
an end wall, and
at least one side wall extending from a first end connected to the end wall to a distal second end, the at least one side wall further comprising a waste aperture, and the at least one side wall further comprising at least one slit extending from the second end towards the first end.

2. The lid according to claim 1, wherein the at least one side wall extends from the perimeter of the end wall.

3. The lid according to claim 1, wherein the at least one side wall extends to define a perimeter greater than that of the end wall.

4. The lid of claim 1, wherein a perimeter defined by the end wall and a perimeter defined by at least one side wall are substantially the same geometric shape.

5. The lid according to claim 1, wherein the slit extends perpendicularly from the distal second end towards the first end.

6. The lid according to claim 1, wherein the slit is tapered where it meets the distal second end.

7. The lid according to claim 1, wherein a termination of the slit distal from the distal second end comprises a circular aperture.

8. The lid according to claim 1, wherein the lid comprises a pair of opposing slits.

9. The lid according to claim 1, further comprising at least one tab extending outwardly from the at least one side wall.

10. The lid according to claim 9, wherein the at least one tab terminates adjacent to the slit.

11. The lid according to claim 9, wherein the at least one tab extends outwardly from the distal second end of the at least one side wall.

12. The lid according to claim 9, wherein the at least one tab extends outwardly from a majority of a perimeter of the at least one side wall.

13. The lid according to claim 9, wherein the at least one tab comprises a plurality of tabs.

14. The lid according to claim 13, wherein the plurality of tabs are equally spaced around a perimeter of the at least one side wall.

15. The lid according to claim 9, wherein the at least one tab comprises a planar engagement face.

16. The lid according to claim 1, wherein the end wall is curved.

17. The lid according to claim 1, further comprising at least one handle extending outwardly from the end wall.

18. The lid according to claim 1, further comprising at least one fin extending into the container interior.

19. The lid according to claim 1, wherein the lid has a circular perimeter.

20. A sanitary bin comprising:
a bin portion comprising a base and a tapered tube extending and broadening from the base to form a bin interior;
a lid comprising a container with a container interior, the container comprising:
an end wall, and
at least one side wall extending from a first end connected to the end wall to a distal second end, the at least one side wall further comprising a waste aperture, and the at least one side wall further comprising at least one slit extending from the second end towards the first end
wherein the lid is sized to fit within the tapered tube, and
wherein the lid is slidably movable within the tapered tube, such that the sliding motion of the lid towards the base of the bin portion exerts a force on the lid such that the at least one slit narrows in width.

21. The sanitary bin according to claim 20, wherein the bin portion further comprises at least one flange extending into the bin interior from the tapered tube, wherein the lid further comprises at least one tab extending outwardly from the at least one side wall, and wherein the at least one flange and the at least one tab engage to prevent complete removal of the lid from the tapered tube.

22. A sanitary bin according to claim 20, wherein the at least one flange is located at the end of the tapered tube distal from the base.

23. A sanitary bin according to claim 20, wherein the at least one flange extends around a majority of a perimeter of the tapered tube.
